(19) United States
(12) Patent Application Publication
(10) Pub. No.: US 2026/0099746 A1
(43) Pub. Date: Apr. 9, 2026

(54) QUANTUM STATE INITIALIZATION METHOD, QUANTUM STATE INITIALIZATION DEVICE, AND QUANTUM COMPUTER SYSTEM INCLUDING QUANTUM STATE INITIALIZATION DEVICE

(71) Applicant: KOREA ADVANCED INSTITUTE OF SCIENCE AND TECHNOLOGY, Daejeon (KR)

(72) Inventors: Joonwoo BAE, Daejeon (KR); Jiyoung YUN, Daejeon (KR); Jaemin KIM, Daejeon (KR); Seungchan SEO, Daejeon (KR)

(73) Assignee: KOREA ADVANCED INSTITUTE OF SCIENCE AND TECHNOLOGY, Daejeon (KR)

(21) Appl. No.: 19/091,730

(22) Filed: Mar. 26, 2025

(30) Foreign Application Priority Data
Oct. 8, 2024 (KR) 10-2024-0136211

(51) Int. Cl. G06N 10/20; G06N 10/40

(52) U.S. Cl. CPC G06N 10/20; G06N 10/40

(57) ABSTRACT

Provided is a device for initializing a quantum state. The device includes: a control register that receives a quantum state of a control qubit S and outputs a computation result thereon; at least one auxiliary register that receives a quantum state of a target qubit A₁ . . . Aₙ (n is a natural number of 1 or larger) in a one-to-one manner; a collective CNOT gate unit including a plurality of CNOT gates respectively connected to the control registers and connected to the at least one auxiliary register in a one-to-one manner; at least one detector connected to the at least one auxiliary register in a one-to-one manner and configured to measure a computation result of the collective CNOT gate unit; and a quantum state output unit ρ⁽ⁿ⁾ that applies a noise removal protocol based on the measurement result of the detector to output an initialized quantum state from which noise has been removed.

### CROSS-REFERENCE TO RELATED APPLICATIONS

This application claims benefit of priority to Korean Patent Application No. 10-2024-0136211 filed Oct. 8, 2024, the entire content of which is incorporated herein by reference.

### TECHNICAL FIELD

The present disclosure relates to a quantum state initialization method, a quantum state initialization device, and a quantum computer system including the same, and more particularly, to a noise-free quantum state preparation method, a noise-free quantum state initialization device, and a quantum computer system including the same by using a protocol for reducing and removing noise when initialization of a quantum state includes the noise.

### BACKGROUND

The process of preparing for the start of the quantum information processing process is called the initialization of the system, and the purpose of the initialization of the system is to prepare a specific quantum state.

The quantum state initialization is a process of initializing a quantum computer system to a specific quantum state. In this process, the noise occurs when preparing the quantum state due to various factors such as interaction with the surroundings around the quantum computer system or defects of a device that generates the quantum state.

In the quantum computer system, the initialized quantum state without noise may be represented as |0 [symbol] and the quantum state including noise may be represented as

$$ρ = [ \begin{matrix}{ρ}_{00} & {ρ}_{01} \\ {ρ}_{10} & {ρ}_{11}\end{matrix} ] .$$

The f (fidelity) related to the accuracy of the quantum state initialization is defined as follows.

$$f = 〈 0 \vert ρ \vert 0 〉$$

It is necessary to convert the quantum state including the noise into a quantum state without noise.

The method of identifying whether a specific initial state has been prepared is generally assumed as a process of identifying whether the noise is absent. However, the actual environment and the actual quantum technology include noise and thus cannot fully implement the process of preparing and verifying the specific state.

### SUMMARY

A purpose of the present disclosure is to provide a protocol for completing the initialization of a quantum computer for preparing a specific state by utilizing the technology of state preparation and measurement including a noise environment and noise.

A quantum state initialization device according to an embodiment of the present disclosure comprises a control register configured to receive a quantum state of a control qubit S and output a computation result thereon; at least one auxiliary register configured to receive a quantum state of a target qubit A₁ . . . Aₙ (n is a natural number of 1 or larger) in a one-to-one manner; a collective CNOT gate unit including a plurality of CNOT gates respectively connected to the control registers and connected to the at least one auxiliary register in a one-to-one manner; at least one detector connected to the at least one auxiliary register in a one-to-one manner and configured to measure a computation result of the collective CNOT gate unit; and a quantum state output unit ρ⁽ⁿ⁾ configured to apply a noise removal protocol based on the measurement result of the detector to output an initialized quantum state from which noise has been removed.

The quantum state initialization device according to an embodiment of the present disclosure further comprises: a reference value setting unit configured to set a reference value of a quantum fidelity; and a target qubit number determining unit configured to determine a number of target qubits having a quantum state having noise satisfying the set reference value of the quantum fidelity of a final output of a quantum state, and a number of CNOT gates performing a CNOT gate computation on the determined number of target qubits in a one-to-one manner.

Each of the control register and the plurality of auxiliary registers is configured to receive a quantum state having noise.

The collective CNOT gate unit is configured to perform n CNOT gate computations on the n+1 copies of noisy quantum state ρ of one control qubit and n target qubits and on one control qubit S and a first target qubit A₁ to an n-th target qubit Aₙ.

The detector is configured to adopt a control qubit state in response to that all of the results of measuring the computation result of the collective CNOT gate unit on the n target qubits are 0.

As a number n of the target qubits increases, the fidelity converges to 1.

A quantum state initialization method according to an embodiment of the present disclosure comprises preparing (n+1) copies of a noisy quantum state, which includes one control qubit and n target qubits; performing a computation of a collective CNOT gate unit on the (n+1) copies of noisy quantum state ρ; measuring the n target qubits using a detector; and performing a noise removal protocol based on results of measurement of the n target qubits.

The performing of the noise removal protocol includes adopting a control qubit state when all of individual measurement results of the n target qubits are 0.

The performing of the computation of the collective CNOT gate unit includes performing n CNOT gate computations on one control qubit S and a first target qubit A₁ to an n-th target qubit Aₙ.

The adopted control qubit is an initial qubit with reduced noise, wherein as a number n of the target qubits increases, the fidelity converges to 1.

The performing of the computation of the collective CNOT gate unit includes performing n CNOT gate computations on one control qubit S and a first target qubit A₁ to an n-th target qubit Aₙ.

The quantum state initialization method according to an embodiment of the present disclosure further comprises determining a number of target qubits having a quantum state having noise satisfying a set reference value of a quantum fidelity of a final output of the quantum state, and a number of CNOT gates performing a CNOT gate computation on the determined number of target qubits in a one-to-one manner.

According to an embodiment of the present disclosure, when the quantum state having undesired noise is generated in the process of initializing the quantum computer system for quantum information processing, the quantum computer system may be initialized or a specific quantum state to be prepared may be prepared at high accuracy.

According to an embodiment of the present disclosure, the initialization of the quantum state having the noise in the noisy environment, and the measurement of the quantum state are repeatedly performed three times or less, thereby adjusting the noise level of the initialized quantum state to prepare the quantum state having high fidelity.

According to an embodiment of the present disclosure, quantum computer initialization or quantum state preparation may be stably achieved in any environment without improving an environment such that less noise is generated or using equipment in which less noise is generated.

### BRIEF DESCRIPTION OF THE DRAWINGS

FIG. 1 is a block diagram schematically illustrating a configuration of a computer device according to an embodiment of the present disclosure.

FIG. 2 is a diagram illustrating a quantum state initialization device according to an embodiment of the present disclosure.

FIG. 3 is a flowchart illustrating a quantum state initialization method according to an embodiment of the present disclosure.

### DETAILED DESCRIPTION

Embodiments of the present disclosure are described below with reference to the accompanying drawings, which include various details of embodiments of the present disclosure, to facilitate understanding. This is merely an example. Accordingly, those skilled in the art should appreciate that various changes and modifications may be made to the embodiments described herein without departing from the scope and spirit of the present disclosure. Further, for clarity and conciseness, the description of well-known functions and structures will be omitted in the following description.

According to various embodiments, each of the described components may include a single or a plurality of entities. According to various embodiments, one or more components or steps among components or steps may be omitted, or one or more other components or steps may be added. Alternatively or additionally, a plurality of components may be integrated into one component. In this case, the integrated component may perform one or more functions of each component of the plurality of components in the same or similar manner as that performed by a corresponding component of the plurality of components prior to the integration. According to various embodiments, the steps performed by the module, the program, or other components may be sequentially, in parallel with each other, repeatedly, or heuristically executed, one or more of the steps may be executed in a different order, omitted, or one or more other steps may be added.

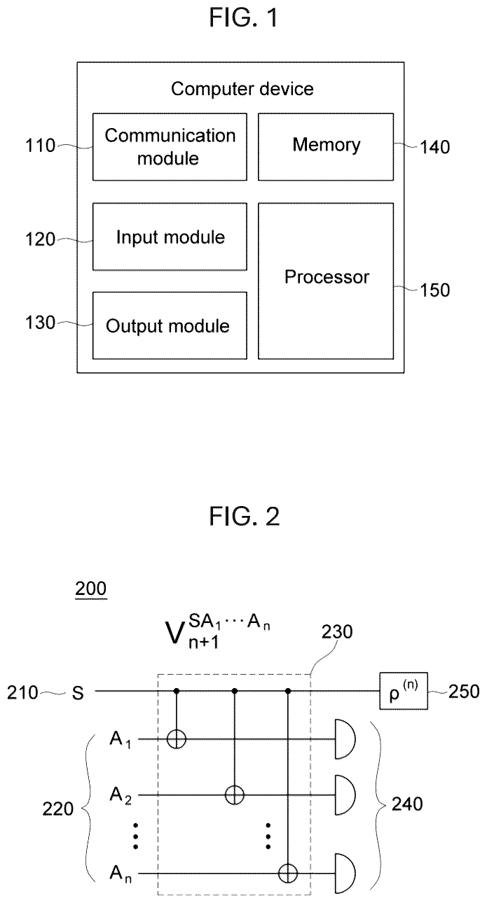

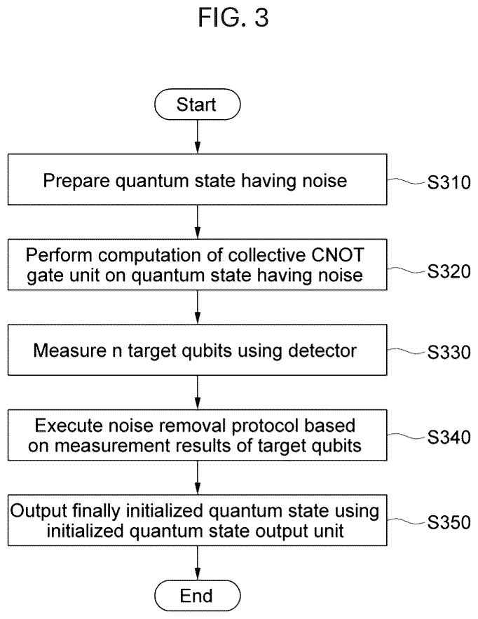

FIG. 1 is a block diagram schematically illustrating a configuration of a computer device according to an embodiment of the present disclosure. FIG. 2 is a diagram illustrating a quantum state initialization device according to an embodiment of the present disclosure. FIG. 3 is a flowchart illustrating a quantum state initialization method according to an embodiment of the present disclosure.

Referring to FIG. 1, a computer device 100 may include at least one of a communication module 110, an input module 120, an output module 130, a memory 140, and a processor 150. In some embodiments, at least one of the components of the computer device 100 may be omitted, and at least one other component may be added thereto. In some embodiments, at least two of the components of the computer device 100 may be implemented into one integrated component.

The communication module 110 in the computer device 100 may communicate with an external device. The communication module 110 may establish a communication channel between the computer device 100 and the external device and communicate with the external device through the communication channel. In this regard, the external device may include at least one selected from a group consisting of another computer device, a base station, and a wireless communication module. The wired communication module may be connected to the external device in a wired manner to communicate with the external device in a wired manner. The wireless communication module may include at least one of a short-range communication module or a long-range communication module. The short-range communication module may communicate with the external device in a short-range communication manner. For example, the short-range communication manner may include at least one selected from a group consisting of Bluetooth, WiFi direct, and Infrared Data Association (IrDA). The long-distance communication module may communicate with the external device in a long-distance communication manner. In this regard, the long-distance communication module may communicate with the external device through a network. For example, the network may include at least one computer network among a group consisting of a cellular network, the Internet, a local area network (LAN) and a wide area network (WAN).

The input module 120 may input a signal to be used for at least one component of the computer device 100. The input module 120 may be configured to detect a signal directly input by a user or to generate a signal based on a detecting result of a change in the surroundings. For example, the input module 120 may include at least one selected from a group consisting of a mouse, a keypad, a microphone, and a sensor module having at least one sensor.

The output module 130 may output information to an outside out of the computer device 100. The output module 130 may include at least one of a display module configured to visually output information or an audio output module capable of outputting information as an audio signal. For example, the audio output module may include at least one of a speaker or a receiver.

The memory 140 may store therein various data used by at least one component of the computer device 100. For example, the memory 140 may include at least one of a volatile memory or a non-volatile memory. The data may include at least one program and input data or output data related thereto. The program may be stored in the memory 140 as software including at least one instruction, and may include at least one selected from a group consisting of an operating system, middleware, or an application.

The processor 150 may execute the program of the memory 140 to control at least one component of the computer device 100. Accordingly, the processor 150 may perform data processing or computation. In this case, the processor 150 may execute a instruction stored in the memory 140.

The computer device 100 according to an embodiment of the present disclosure may be a quantum system that performs quantum computing or quantum communication. Such a quantum system may reduce a computation error only when the computation is performed in the quantum state without noise.

The computing device 100 according to an embodiment of the present disclosure may include a quantum state initialization device 200 for initializing the quantum state so as to be free of the noise in order to perform a quantum computation in at least one of the quantum communication module 110, the input module 120, the output module 130, the memory 140, and the processor 150.

Referring to FIG. 2, the quantum state initialization device 200 according to an embodiment of the present disclosure includes a control register 210 configured to receive a quantum state of a control qubit S and output a computation result, at least one auxiliary register 220 configured to receive a quantum state of a target qubit in a one-to-one manner, an collective CNOT gate unit 230 including a plurality of CNOT gates respectively connected to the control registers 220 and connected to the auxiliary registers 220 in a one-to-one manner, at least one detector 240 connected to the at least one auxiliary register 220 in a one-to-one manner and configured to detect a computation result of the collective CNOT gate unit 230, and a quantum state output unit ρ⁽ⁿ⁾ 250 configured to apply a noise removal protocol based on a measurement result of the detector 240 to output an initialized quantum state from which noise has been removed.

Referring to FIG. 2, the control register 210 receives the quantum state of the control qubit S and outputs a result of performing a computation of the CNOT gate.

The auxiliary register 220 may include n auxiliary registers to receive quantum states of n target qubits A₁ . . . Aₙ (n is a natural number greater than or equal to 1) in a one-to-one manner.

The collective CNOT gate unit 230 includes n CNOT gates respectively connected to the n control registers and connected to the n auxiliary registers in a one-to-one manner.

As illustrated in FIG. 2, the detector 240 may be connected to the auxiliary register 220 in a one-to-one manner, and may include n detectors corresponding to the n auxiliary registers. Unlike FIG. 2, one detector 240 may be connected to all of the n auxiliary registers 220 to detect the computation results of the n CNOT gates.

The detector 240 may measure the quantum state of the target qubit according to the computation result of the CNOT gate applied to the target qubit. In some embodiments, the detector 240 may include an operator that uses a quantum detector tomography (QDT). In some embodiments, the detector 240 may include a quantum circuit for measurement of a quantum state.

The quantum state output unit ρ⁽ⁿ⁾ 250 is configured to apply a noise removal protocol based on the measurement result of the detector 240 to output an initialized computation result from which noise has been removed.

The quantum state initialization device 200 includes the noise removal protocol for removing noise generated when the quantum state is prepared.

The protocol for removing the noise generated when preparing the quantum state may include 1) preparation of the quantum state, 2) computation of the collective CNOT gate unit, and 3) measurement of n target qubits.

The initial quantum fidelity of the noisy quantum state is set to ½<f<1.

The noise removal protocol that restores the quantum fidelity f to be close to 1 is as follows.

### 1) Preparation of Quantum State

The (n+1) copies of noisy quantum state ρ is prepared based on the control qubit S and the target qubits A₁ . . . Aₙ.

The (n+1) copies of noisy quantum state ρ are prepared in the same state, but may include different noise levels due to the internal circuit configuration of the quantum computer or the influence of the external electronic device in the preparation process, and thus may not be completely identical with each other.

### 2) Calculation of Collective CNOT Gate Unit

The collective CNOT gate unit 230 performs a computation on the control qubit S and the target qubit A. When the state of the control qubit is |0>, the collective CNOT gate unit 230 does not compute on the target qubit, and maintains the target qubit in that state |0>. When the state of the control qubit is |1>, the collective CNOT gate unit 230 performs a Pauli X computation corresponding to the NOT computation on the target qubit.

The collective CNOT gate unit 230 performs n CNOT gate computations on one control qubit and the first target qubit A₁ to the n-th target qubit Aₙ.

More specifically, the collective CNOT gate unit 230 sets a qubit from which the noise is to be removed as the control qubit S and sets n auxiliary qubits for removing the noise as the target qubits A₁ . . . Aₙ, and performs the CNOT gate computation as follows.

The CNOT gate computation is performed between the control qubit S and the first target qubit A₁.

The CNOT gate computation is performed between the control qubit S and the second target qubit A₂.

The CNOT gate computation is performed between the control qubit S and the n-th target qubit Aₙ until the computation on the n-th target qubit as finally set is achieved.

The computation of the collective CNOT gate unit 230 on the (n+1) copies of noisy quantum state ρ of the control qubit S input to one control register 210 and the target qubits A₁ . . . Aₙ input to the n auxiliary registers 220 are mixed with each other is defined as follows.

$$\begin{matrix}{{{V}_{n + 1}^{{SA}_{1} … {A}_{n}} = \vert 0 〉 〈 0 \vert}^{S} ⊗ {I}^{⊗ n} + \vert 1 〉 〈 1 \vert}^{S} ⊗ {X}^{⊗ n} \\ = {V}_{n}^{{SA}_{2} … {A}_{n}} {V}_{2}^{{SA}_{2}} = {V}_{n - 1}^{{SA}_{2} … {A}_{n}} {V}_{2}^{{SA}_{2}} {V}_{2}^{{SA}_{2}} = {\prod }_{i = 1}^{n} {V}_{2}^{{SA}_{i}}\end{matrix} \qquad Equation 1$$

In this regard, X represents a Pauli-X gate, and the CNOT gate is applied to the quantum state of the control qubit S input to the control register 210 and the quantum state of the target qubit Aᵢ input to the auxiliary register 220.

The operation of the CNOT gate unit 230 is as follows. When the control qubit S is in the |0 [symbol] state, the state of the target qubit Aᵢ does not change, and in this case, the identity matrix I is applied to the target qubit Aᵢ. When the control qubit S is in the |1 [symbol] state, the state of the target qubit Aᵢ is inverted by the Pauli-X gate. Thus, the |0 [symbol] state is converted to |1 [symbol] and the state is converted to the |0 [symbol] :

$${{{V}_{2}^{SA} = \vert 0 〉 〈 0 \vert}^{S} ⊗ I + {V}_{2}^{SA} = \vert 1 〉 〈 1 \vert}^{S} ⊗ X \qquad Equation 2$$

The collective CNOT gate unit 230 applies a computation to a noisy quantum state composed of (n+1) qubits and applies the n CNOT gates to a quantum state of the control qubit S input to the control register 210 and a quantum state of the n target qubits A₁ . . . Aₙ input to the n auxiliary registers 220, respectively.

When the control qubit S is in the state |0 [symbol] the identity matrix is applied to the n target qubits A₁ . . . Aₙ, and each of the n target qubits A₁ . . . Aₙ maintains the current quantum state. When the control qubit S is in the |1 [symbol] state, the state of each of the n target qubits A₁ . . . Aₙ is converted by the Pauli-X gate such that the state is converted to |1 [symbol] and the |1 [symbol] state is converted to the |0 [symbol] :

$${{{V}_{n + 1}^{{SA}_{1} … {A}_{n}} = \vert 0 〉 〈 0 \vert}^{S} ⊗ {I}^{⊗ n} + \vert 1 〉 〈 1 \vert}^{S} ⊗ {X}^{⊗ n} \qquad Equation 3$$

Equation 3 represents a process in which each of the CNOT gates of the collective CNOT gate unit 230 is sequentially applied to each target qubit Aᵢ in a one-to-one correspondence manner.

For example, the computation of the CNOT gate applied to the control qubit S and the first target qubit A₁ is denoted

$${V}_{2}^{{SA}_{1}} .$$

Thus, the computation of the collective CNOT gate is multiplication between

$${V}_{2}^{{SA}_{1}} , {V}_{2}^{{SA}_{2}} , ⋯ , {V}_{2}^{{SA}_{n}} :$$

$${V}_{n}^{{SA}_{2} ⋯ {A}_{n}} {V}_{2}^{{SA}_{1}} = {V}_{n - 1}^{{SA}_{s} ⋯ {A}_{n}} {V}_{2}^{{SA}_{2}} {V}_{2}^{{SA}_{1}} = {\prod }_{i = 1}^{n} {V}_{2}^{{SA}_{i}}$$

3)-1 where the Measurement is Performed on n Target Qubits Using Noise-Free Detector

The quantum states of the n target qubits as calculated by applying the collective CNOT gate unit 230 to the n target qubits are measured using the noise-free detector M 240 {M₀=|0 [symbol] [symbol] 0|, M₁=|1 [symbol] [symbol] 1|}. When all of the n results on the target qubit are 0, that is, 0ⁿ, the result state of the control register is indicated as ρ⁽ⁿ⁾.

The process of outputting the quantum state from which the noise has been removed is as follows in more detail.

### Initial Quantum State

The initial quantum state of the control qubit input to the control register 210 and the target qubit input to the n auxiliary registers 220 is expressed as ρ^{⊗n+1}. The computation Vₙ₊₁ of the collective CNOT gate unit 230 is applied to the initial state:

$${V}_{n + 1} {ρ}^{⊗ n + 1} {V}_{n + 1}^{†} \qquad Equation 4$$

### Measurement of n Target Qubits

$${tr}_{{A}_{s} ⋯ {A}_{n}} [ {V}_{n + 1} {ρ}^{⊗ n + 1} {V}_{n + 1}^{†} ( I ⊗ {M}_{0}^{⊗ n} ) ] \qquad Equation 5$$

In this regard, tr_{A}_{₁} _{. . . A}_{ₙ} refers to a partial trace function on the target qubits A₁ . . . Aₙ and corresponds to a process of individually measuring the target qubits excluding the control qubit S. At least one detector 240 is utilized to individually measure n target qubits.

The detector 240 adopts a control qubit state when all of results of measuring the computation results of the collective CNOT gate unit on the n target qubits are zero.

### Final Output of the Control Register

When all of the measurement results of the target qubit are zero, this result is expressed 0ⁿ.

In this regard, the quantum state output unit ρ⁽ⁿ⁾ 250 applies the noise removal protocol based on the measurement result of the detector on the computation result of the collective CNOT gate unit 230 to output the initialized quantum state in which noise has been removed. The final output of the quantum state output unit ρ⁽ⁿ⁾ 250 by applying the noise removal protocol may be expressed based on Equation 6:

$${ρ}^{( n )} = \frac{1}{{p}_{succ}} {tr}_{{A}_{s} ⋯ {A}_{n}} [ {V}_{n + 1} {ρ}^{⊗ n + 1} {V}_{n + 1}^{†} ( I ⊗ {M}_{0}^{⊗ n} ) ] . \qquad Equation 6$$

In this regard, n corresponds to the number of target qubits as used, and p_{succ} is a probability that all n target qubits are measured in the state.

3)-2 where n Target Qubits are Measured Using Noisy Detector

The measurement is performed on the quantum states of the n target qubits output after the collective CNOT gate unit 230 is applied thereto, using n noisy detectors \tilde{M}ᵢ=(1−q)Mᵢ+qM₁. In this regard, Mᵢ=|i [symbol] [symbol] i|, i∈{0,1} and ī=(i+1) mod 2. The inaccuracy of the detector 240 is indicated as an error rate z, and the error rate of the detector is assumed as 0≤q≤½.

When all results of measuring the n target qubits using the noisy detector 240 are 0, that is, 0ⁿ, the result state of the control qubit is indicated as ρ⁽ⁿ⁾.

When the measurement is performed on the n target qubits using the noisy detector 240, the quantum state output unit ρ⁽ⁿ⁾ 250 may apply the noise removal protocol based on the measurement result of the detector 240 on the computation result of the collective CNOT gate unit 230 to output the initialized quantum state from which the noise has been removed. The final output of the quantum state output unit ρ⁽ⁿ⁾ 250 via the application of the noise removal protocol may be expressed based on Equation 7:

The final output and success probability of the quantum state are as follows.

$${ρ}^{( n )} = \frac{1}{{p}_{succ}} {tr}_{{A}_{1} ⋯ {A}_{n}} [ {V}_{n + 1} {ρ}^{⊗ n + 1} {V}_{n + 1}^{†} ( I ⊗ {M}_{0}^{⊗ n} ) ] \qquad Eqaution 7$$

$${p}_{succ} = {α}^{n} f + {( 1 - α )}^{n} ( 1 - f ) ,$$

The quantum fidelity of ρ⁽ⁿ⁾ is

$${f}^{( n )} = \frac{{α}^{n} f}{{α}^{n} f + {( 1 - α )}^{n} ( 1 - f )} .$$

As the number n of the target qubits increases, the quantum fidelity converges to 1, that is, the quantum state is purified to a state without noise. In this regard, α=f(1−q)+(1−f)q. n corresponds to the number of target qubits as used, and p_{succ} refers to a probability that the measurement results of all n target qubits are zero.

Consequently, the control qubit adopted by the detector 240 is finally output as the initial qubit with reduced noise. In addition, as the number n of the target qubits increases, the probability that noise of the control qubit is removed converges to 1.

The noise removal protocol according to an embodiment of the present disclosure alleviates a quantum state preparation error even when there is noise in the detector.

When an error rate of each of the quantum state preparation and measurement is (1−f,q), the error of the quantum state preparation is reduced by using the noise removal protocol using the n target qubits.

TABLE 1

| (1 − f, q) | f⁽ⁿ⁾ |
|---|---|
| (0.1, 0) | f⁽¹⁾ = 0.988 f⁽²⁾ = 0.999 |
| | f^{(∞)} = 1 |
| (0.1, 0.1) | f⁽¹⁾ = 0.976 f⁽²⁾ = 0.995 |
| | f⁽³⁾ = 0.999 |
| | f^{(∞)} = 1 |

Referring to Table 1, when the noise-free detector is used, that is, when the error rate of the state preparation is 0.1 and the measurement error rate is 0, the quantum fidelity is 0.999 even when a computation of the collective CNOT-gate unit 230 is performed on one control qubit and two target qubits, so that a quantum state with little noise may be prepared.

In addition, when the noisy detector is used, for example, when the error rate of state preparation is 0.1 and the measurement error rate is 0.1, the quantum fidelity is 0.999 when a noise removal protocol is performed on one control qubit and three target qubits, so that a quantum state with little noise may be prepared.

The device for initializing the quantum state according to an embodiment of the present disclosure may further include a reference value setting unit for setting a reference value of the quantum fidelity f⁽ⁿ⁾, and a target qubit number determination unit for determining the number of target qubits having a quantum state in which noise is present in order to satisfy a set reference value of the quantum fidelity of a final output ρ⁽ⁿ⁾ of the quantum state, and for determining the number of CNOT gates for receiving the determined number of target qubits and performing the CNOT gate computation thereon in a one-to-one manner.

For example, when the quantum fidelity f⁽ⁿ⁾ set in the reference value setting unit is 0.999 and the noisy detector is used, for example, when the error rate of the state preparation is 0.1 and the measurement error rate is 0.1, the quantum fidelity is 0.995 when the collective CNOT gate computation is performed on one control qubit and two target qubits. Thus, the quantum fidelity 0.995 is lower than the set quantum fidelity of 0.999, and thus the collective CNOT gate computation control unit determines the number n of quantum states of the target gate with noise to be three or more and performs the noise removal protocol based on the determined number.

FIG. 3 is a flowchart illustrating a quantum state initialization method of a computer device according to an embodiment of the present disclosure.

Referring to FIG. 3, the computer device prepares a quantum state in which noise is present in S310. For example, the processor 150 prepares the (n+1) copies of noisy quantum state ρ related to the control qubit S and the n target qubits A₁ . . . Aₙ.

The quantum computer system may represent the quantum state to be initialized as Et and may represent the quantum state including the noise as

$$ρ = [ \begin{matrix}{ρ}_{00} & {ρ}_{01} \\ {ρ}_{10} & {ρ}_{11}\end{matrix} ] .$$

The fidelity f on the accuracy of the quantum state initialization is defined as follows.

$$f = 〈 0 \vert ρ \vert 0 〉$$

Next, the quantum state initialization device performs a computation of the collective CNOT gate unit on the (n+1) copies of noisy quantum state ρ in S320.

The collective CNOT gate unit performs n CNOT gate computations on one control qubit S and the first target qubit A₁ to the n-th target qubit Aₙ.

The computation of the collective CNOT gate unit may be defined based on Equation 1.

$$\begin{matrix}{{{V}_{n + 1}^{{SA}_{1} ⋯ {A}_{n}} = \vert 0 〉 〈 0 \vert}^{S} ⊗ {I}^{⊗ n} + \vert 1 〉 〈 1 \vert}^{S} ⊗ {X}^{⊗ n} \\ = {V}_{n}^{{SA}_{s} ⋯ {A}_{n}} {V}_{2}^{{SA}_{1}} \\ = {V}_{n - 1}^{{SA}_{s} ⋯ {A}_{n}} {V}_{2}^{{SA}_{2}} {V}_{2}^{{SA}_{1}} \\ = {\prod }_{i = 1}^{n} {V}_{2}^{{SA}_{i}}\end{matrix} \qquad Equation 1$$

In this regard, I represents the identity matrix, X represents a Pauli-X gate, and the CNOT gate is applied to a quantum state of the control qubit S input to the control register and a quantum state of the target qubit Aᵢ input to the auxiliary register.

The initial quantum states of the control qubit input to the control register and the target qubits input to the n auxiliary registers are expressed as ρ^{(⊗n+1)}.

Accordingly, applying the collective CNOT gate computation Vₙ₊₁ to the n+1 initial quantum states is expressed based on Equation 4:

$${V}_{n + 1} {ρ}^{⊗ n + 1} {V}_{n + 1}^{†} \qquad Equation 4$$

Next, the n target qubits are measured using the detector in S330. The measurement of the n target qubits is expressed based on Equation 5.

$${tr}_{{A}_{1} ⋯ {A}_{n}} [ {V}_{n + 1} {ρ}^{⊗ n + 1} {V}_{n + 1}^{†} ( I ⊗ {M}_{0}^{⊗ n} ) ] \qquad Equation 5$$

In this regard, tr_{A}_{₁} _{. . . A}_{ₙ} refers to a partial trace function on the target qubits A₁ . . . Aₙ and represents a process of leaving only the quantum state of the control qubit.

Next, the noise removal protocol based on the measurement results of the n target qubits is performed in S340.

The noise removal protocol may be expressed based on Equation 6.

$${ρ}^{( n )} = \frac{1}{{p}_{succ}} {tr}_{{A}_{1} ⋯ {A}_{n}} [ {V}_{n + 1} {ρ}^{⊗ n + 1} {V}_{n + 1}^{†} ( I ⊗ {M}_{0}^{⊗ n} ) ] . \qquad Equation 6$$

In this regard, n corresponds to the number of target qubits as used, and p_{succ} refers to a probability that all measurement results of the n target qubits are zero.

$${p}_{succ} = {α}^{n} f + {( 1 - α )}^{n} ( 1 - f ) .$$

The quantum fidelity of ρ⁽ⁿ⁾ is

$${f}^{( n )} = \frac{{α}^{n} f}{{α}^{n} f + {( 1 - α )}^{n} ( 1 - f )} .$$

As the number n of target qubits increases, the quantum fidelity converges to 1, that is, the quantum state is purified to a state without noise. In this regard, α=f(1−q)+(1−f)q.

When all of the individual measurement results of n target qubits are 0, the control qubit state is adopted. The adopted control qubit is an initial qubit in which the noise is lowered, and as the number of target qubits n increases, the probability that noise of the control qubit is removed converges to 1.

Finally, the initialized quantum state output unit ρ⁽ⁿ⁾ connected to the control register finally outputs the initialized quantum state in S350.

In one example, although not shown, the method for initializing the quantum state of the computer device according to an embodiment of the present disclosure may further include determining the number n of target qubits having a quantum state having noise in which the final output of the quantum state satisfies the reference value or greater of the quantum fidelity and the number n of the CNOT gates performing the CNOT gate computation.

The device and method as described above may be implemented as hardware components, software components, and/or a combination of hardware components and software components.

For example, the device and components described in the embodiments may be implemented using one or more general purpose computers or special purpose computers, such as a processor, a controller, an Arithmetic Logic Unit (ALU), a digital signal processor, a microcomputer, a Field Programmable Gate Array (FPGA), a Programmable Logic Unit (PLU), a microprocessor, or any other device capable of executing and responding to instructions. The processing device may perform an operating system and one or more software applications executed on the operating system. In addition, the processing device may access, store, manipulate, process, and generate data in response to execution of the software. For the convenience of understanding, it may be described that one processing device is used, but a person skilled in the art may appreciate that the processing device may include a plurality of processing elements and/or a plurality of types of processing elements. For example, the processing device may include a plurality of processors or one processor and one controller. Other processing configurations such as parallel processors are also possible.

The software may include a computer program, code, instructions, or a combination of one or more thereof, and may configure the processing device to operate as desired or may instruction the processing device independently or collectively. Software and/or data may be embodied in any type of machine, component, physical device computer storage medium or device to be interpreted by the processing device or to provide instructions or data to the processing device. The software may be distributed on a networked computer system and stored or executed in a distributed manner. Software and data may be stored in one or more computer-readable recording media.

The method according to various embodiments may be implemented in the form of program instructions that may be executed through various computer means and recorded in a computer-readable medium. In this case, the medium may be continuously storing a computer-executable program or temporarily storing the computer-executable program for execution or download. The medium may be various recording means or storage means in the form of a single or a combination of several hardware, and may be distributed on a network without being limited to a medium directly connected to any computer system. Examples of the media may include magnetic media such as a hard disk, a floppy disk, and a magnetic tape, optical recording media such as CD-ROM and DVD, magneto-optical media such as a floptical disk, and ROM, RAM, flash memory, and the like. In addition, examples of other media include an application store that distributes applications, a site that supplies or distributes various other software, and a recording medium or a storage medium managed by a server.

What is claimed is:

1. A quantum state initialization device comprising:
a control register configured to receive a quantum state of a control qubit S and output a computation result thereon;
at least one auxiliary register configured to receive a quantum state of a target qubit A₁ . . . Aₙ (n is a natural number of 1 or larger) in a one-to-one manner;
a collective CNOT gate unit including a plurality of CNOT gates respectively connected to the control registers and connected to the at least one auxiliary register in a one-to-one manner;
at least one detector connected to the at least one auxiliary register in a one-to-one manner and configured to measure a computation result of the collective CNOT gate unit; and
a quantum state output unit ρ⁽ⁿ⁾ configured to apply a noise removal protocol based on the measurement result of the detector to output an initialized quantum state from which noise has been removed.

2. The quantum state initialization device of claim 1, wherein the quantum state initialization device further comprises:
a reference value setting unit configured to set a reference value of a quantum fidelity; and
a target qubit number determining unit configured to determine a number of target qubits having a quantum state having noise satisfying the set reference value of the quantum fidelity of a final output of a quantum state, and a number of CNOT gates performing a CNOT gate computation on the determined number of target qubits in a one-to-one manner.

3. The quantum state initialization device of claim 1, wherein each of the control register and the plurality of auxiliary registers is configured to receive a quantum state having noise.

4. The quantum state initialization device of claim 3, wherein the collective CNOT gate unit is configured to perform n CNOT gate computations on the (n+1) copies of noisy quantum state ρ of one control qubit and n target qubits and on one control qubit S and a first target qubit A₁ to an n-th target qubit Aₙ.

5. The quantum state initialization device of claim 4, wherein the detector is configured to adopt a control qubit state in response to that all of results of measuring the computation result of the collective CNOT gate unit on the n target qubits are 0.

6. The quantum state initialization device of claim 5, wherein as a number n of the target qubits increases, the fidelity converges to 1.

7. A quantum state initialization method comprising:
preparing (n+1) copies of a noisy quantum state, which includes one control qubit and n target qubits;
performing a computation of a collective CNOT gate unit on the (n+1) copies of noisy quantum state ρ;
measuring the n target qubits using a detector; and
performing a noise removal protocol based on results of measurement of the n target qubits.

8. The quantum state initialization method of claim 7, wherein the performing of the noise removal protocol includes adopting a control qubit state when all of individual measurement results of the n target qubits are 0.

9. The quantum state initialization method of claim 8, wherein the adopted control qubit is an initial qubit with reduced noise,
wherein as a number n of the target qubits increases, the fidelity converges to 1.

10. The quantum state initialization method of claim 7, wherein the performing of the computation of the collective CNOT gate unit includes performing n CNOT gate computations on one control qubit S and a first target qubit A₁ to an n-th target qubit Aₙ.

11. The quantum state initialization method of claim 7, wherein the method further comprises determining a number of target qubits having a quantum state having noise satisfying a set reference value of a quantum fidelity of a final output of the quantum state, and a number of CNOT gates performing a CNOT gate computation on the determined number of target qubits in a one-to-one manner.
